(19) United States
(12) Patent Application Publication
(10) Pub. No.: US 2004/0031835 A1
(43) Pub. Date: Feb. 19, 2004

(54) Hunter's ammunition cartridge holder for vehicle

(76) Inventors: Everett W. McLeod, Lee, ME (US); Roger D. Powers, Medway, ME (US); Galen W. McLaughlin, Medway, ME (US); Ronald E. McLeod, Mattawamkeag, ME (US)

Correspondence Address: PEDERSEN & COMPANY, PLLC, P.O. BOX 2666, BOISE, ID, 83701, US

(21) Appl. No.: 10/222,510

(22) Filed: Aug. 14, 2002

(51) Int. Cl. B60R 7/00; B60R 9/00; B60R 11/00

(52) U.S. Cl. 224/544

(57) ABSTRACT

An ammunition holder fits into a vehicle cup-holder, for organizing gun-shot shells and rifle cartridges in a pattern of open-topped, closed-bottom bores in the top of the holder. The shells and cartridges are held in separate, spaced bores, so that they do not touch and so that they are individually removable by lifting up on the exposed top ends of the shells/cartridges. The ammunition holder is slidably received in the cup-holder, preferably without tools, adhesives, or fasteners, and the shells and cartridges are also slidably received in the holder without fasteners or other obstacles to removal. The shells and cartridges do not hang from the holder but rather stand upright and loose in the bores, resting on the floor walls of the bores. The bores may be sized in length so that the top, exposed ends of the shells and cartridges protrude different distances above the holder, thus, creating a three-dimensional arrangement of shells and cartridges that is convenient for recognizing and accessing the desired shells and cartridges. With the ammunition holder(s) in the cup-holder(s) between the front seats of the pick-up truck or other vehicle, the driver and/or passenger may quickly access and select the desired type and size of ammunition cartridge, remove it with one hand, and load it in a gun for use.

### BACKGROUND OF THE INVENTION

1. Field of the Invention

The invention relates, in general, to holders for ammunition for hunters and recreational shooters. More specifically, this invention relates to a holder for ammunition cartridges, including rifle cartridges and shot-gun shells, for bird, deer, or small game hunters that keeps the ammunition cartridges organized and easily-reachable in a vehicle. The invented holder is adapted for use in a vehicle's cup-holder.

2. Related Art

Ammunition holders have been developed for hunters and shooters that connect the holder to the user's vest, belt or other wearing apparel. For example, many vests include loops, pockets, or other containing means that hold either boxes of ammunition or individual ammunition cartridges. This way, the hunter may carry the ammunition cartridges with him without holding it in his/her hand and then may reach for a shot-gun shell or rifle cartridge when needed by sliding the shell/cartridge out of the loop or opening the pocket or pouch.

Various patents describe special systems for holding ammunition. For example, Jewell, deceased et al. (U.S. Pat. No. 4,843,6490) discloses a shell holder sewn to a jacket, coat, vest, or life vest. The shell holder includes vertical cloth “loops” that receive shotgun shells end-to-end in their vertical interior spaces. At the bottom of each loop interior space is a dispenser tube for revealing the bottom of the bottom-most shell in each loop, and for allowing access by the user to that shell bottom. To remove the shell, the user grasps the bottom end of the bottom shell in a particular dispenser tube to pull the shell down and out past the dispenser tube's flexible fingers that are biased inward against the shell. Once the shell is removed, the next shell falls down into place in the dispenser tube for being dispensed.

Johnson et al. (U.S. Pat. No. 5,924,613) discloses a shell holder system that hangs from apparel, structures, or vehicles. The Johnson system includes an elongated, generally planar rack portion attached to a vertical surface, plus receivers with sliding engagement members that cooperate with and attach to the rack portion. The rack is flexible at its ends and between the areas when the receivers are held. In the receiver, there are shell-sized bores through which the user's shells hang, with the top end (rim) of the shell hanging on a ledge at the top of the receiver and the bottom end of the shell depending down from, and exposed below, the bottom of the receiver. To remove a shell, the user pushes up on the bottom of the shell that is exposed below the receiver, in order to push the shell up and out of the receiver so that the user may then grasp the rim of the shell.

Still, there is a need for a simple and effective ammunition cartridge holder that may used in a vehicle to organize the user's shells and cartridges. There is a need for such a holder that is simple to install, easy to use, and easy to remove from the vehicle. There is a need for a safe holder that is effective and easy for use with one hand, which contributes to safe gun and ammunition handling, minimizing the possibility of a person fumbling with, or dropping, the ammunition cartridges. The present invention meets these needs.

### SUMMARY OF THE INVENTION

The present invention comprises a holder for ammunition that is adapted to be installed in a cup-holder of a vehicle. The invented holder is preferably sized and shaped to slide into and out of the standard cup-holder in a vehicle, to be easily installed and easily removed from the cup-holder and from the vehicle preferably without tools, fasteners, and adhesives, and without significant effort.

The invented ammunition cartridge holder comprises generally vertical bores, spaced around its top surface, that receive variously-sized cartridges and/or shells so that the top end of the cartridges or shells are held up above the top surface and are accessible to the user. The shells and cartridges are preferably all separated from each other by the bore walls, with only one shell or cartridge being in each bore and, hence, being generally protected from damage and friction. Further, all the bores and all the shells and cartridges are preferably clustered in concentric circles or multiple rows/columns in a generally cylindrical space or generally square space, rather than being spread out in a single row along an elongated belt or rack. This spaced-apart but compact arrangement serves to place a large number of shells or cartridges within reach of the user in a manner that makes single shells or cartridges easily and safely grasped.

Then preferred embodiment has a bottom portion that is sized to fit into a conventional cup-holder in a pick-up or other vehicle, and an enlarged top portion, that is, enlarged radially relative to the bottom portion. The enlarged top portion provides space for a plurality of cartridge and shell bores preferably extending axially into the invented holder. Preferably about 13 of the bores are spaced around the top in concentric circles and at the axis of the holder. The diameters of the bores are designed to be slightly larger than the outside diameter of the ammunition cartridges, so that the ammunition cartridges (both shot-gun shells and rifle cartridges) slide into and out of the bores easily. The bottom of each bore is closed, to provide a floor for an end of each ammunition cartridge to rest against, and the axial length of each bore is sized so that the ammunition cartridge, when resting on the floor, extends a distance above the top surface sufficient for grasping by the user. This way, the user may safely insert the cartridges/shells into their respective bores, and then grasp them one by one with one hand, when needed. The user simply lifts the selected cartridge or shell out of its bore, without complex motions that may cause dropping or fumbling.

The objects of the invention, therefore, include providing a safe, sturdy, and simple ammunition holder that cooperates with a conventional cup-holder in a pick-up or other vehicle. It is an object to provide such a holder that keeps the ammunition organized and close-at-hand, for hunters that drive through the country or mountains scouting for birds and game. It is a further object to keep the ammunition handy for both the driver and the passenger, wherein they do not have to retrieve the ammunition cartridges out of a box, a glove compartment or the back of the vehicle. This allows convenient, quick, and sure access, without placing the ammunition in any position that might interfere with driving or with ingress into and egress out of the vehicle. It is further an object to have a holder from which the ammunition cartridges may be removed for use with only one hand and with only a single, smooth upward motion of lifting one end of the cartridge. It is further an object of the invention to have the holder easily and completely installed, and, likewise, easily and completely removable from the vehicle preferably without tools, adhesives, hook and loop fastener, or other fasteners or moving parts. Thus, the invention provides a holder that can be transferred from vehicle to vehicle without leaving any parts and without leaving a trace in the vehicle.

### BRIEF DESCRIPTION OF THE DRAWINGS

FIG. 1 is a perspective view of one embodiment of the invented hunter's ammunition holder for a vehicle, without any ammunition cartridges in the holder.

FIG. 2 is a perspective view of the holder of FIG. 1, with a plurality of shells and cartridges installed in the holder.

FIG. 3 is a cross-sectional side view of the holder of FIGS. 1 and 2, showing three cartridges and two shells in the holder, and illustrating the holder installed in one embodiment of a cup-holder of a vehicle.

FIG. 4 is a top view of the holder of FIGS. 1-3.

FIG. 4a is a top view of an alternative holder according to the invention, having an especially-preferred bore arrangement.

FIG. 5 is a top view of another alternative embodiment of the invented holder, wherein the top, receiver portion of the holder is a square shape having rings of bores.

FIG. 5a is a top view of another alternative embodiment of the invented holder, wherein the receiver portion is a square shape having rows and columns of bores.

### DESCRIPTION OF THE PREFERRED EMBODIMENTS

Referring to the Figures, there are shown several, but not the only, embodiments of the invented hunter's ammunition cartridge holder for a vehicle. The term “ammunition cartridge” is herein used to include various types of individual pieces of ammunition for hunters and recreational shooters, for example, shot-gun shells and cartridges such as rifle cartridges, for example. The invented holder is preferably sized and shaped to cooperate with the conventional cup-holder CH of a vehicle, which is usually in-between the driver and the passenger. Originally designed to receive and support the driver's and passenger's soda-pop disposable cups or coffee mugs, these cup-holders are well-known means for allowing the user to use and stow a beverage cup while driving or while riding in a vehicle. Conventional cup-holders holders typically comprise a recessed well or a bracket with extending arms, which are both designed to receive the bottom end of the drinking cup or mug. In a Ford Explorer™, for example, two cup-holders are positioned side-by-side between the drivers's seat and the front passenger seat, and each of the two cup-holders is a molded, cylindrical recessed well that is about 1.5 inches deep.

The instant invention is an ammunition holder 10 that may be used in conventional cup-holders of the Ford vehicle, in Dodge, Chevrolet, or other vehicles, to keep shells 12 and cartridges 14 safety stowed but handy for the driver and passenger who may be driving through the countryside and woodland areas scouting for game and birds. When game or birds are spotted, the driver or passenger may easily reach for the ammunition of their choice, the gun of their choice, and quickly and easily exit the vehicle to hunt. The invented holder 10 prevents the hunter from having to wear a heavy ammunition vest. In areas that allow hunting from a vehicle, such as on private roads or off-road, the hunter may actually choose to grasp the ammunition from the holder and load or reload, and then shoot from the vehicle. Certainly, the hunters should use proper precautions to prevent unsupervised youth or other unauthorized or unskilled parties from gaining access to the holder containing ammunition.

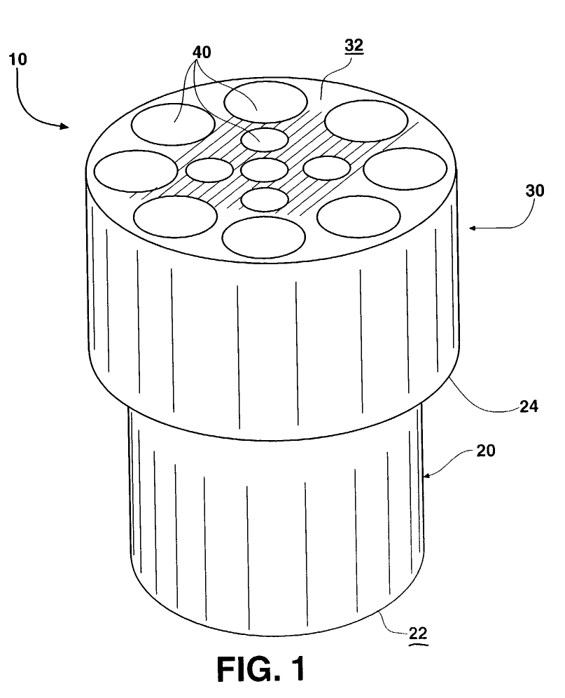

FIGS. 1-4 illustrate a preferred embodiment of the ammunition holder 10, wherein the holder is generally is a cylindrical outer shape, with a lower end or “base” 20 having an outer diameter that fits inside a cup-holder CH. Vehicle cup-holders tend to vary somewhat in size and depth and style, but the inventors believe that a small number of invented holders 10, with different-diameter bases and possibly different base heights, may be produced that will fit well in the most popular vehicles. Typically, the invented holder 10 will have a base 20 with an outer diameter the same or similar to a standard 16 oz-32 oz. soda pop cup, or the same or similar to a 8-12 oz. coffee mug. This places the preferred dimensions of the base 20 in the range of about 2¼-3 inches in diameter and about 1.5-2.5 inches high. Preferably, the lower portion (base 20) of the holder 10 is only slightly less in diameter than the cup-holder CH in which it is intended to fit, for example, from preferably about 1/4 inches up to preferably at most 1/2 inches less than the cup-holder diameter.

The base 20 may be defined at the lower portion of the holder 20, with its lower extremity being the bottom surface 22 and its upper extremity being at or near the “flange” or “shoulder” 24 where the diameter of the holder is increased to form the enlarged top portion or “receiving portion” 30 of the holder. The shoulder 24 marks the transition from the base 20 to the receiving portion 30 that holds the shells and cartridges. The base 20 may be tapered inward from the shoulder 24 to the bottom surface 22, but, more preferably, the base 20 has a generally constant diameter all along its height. Most preferably, the base 20 is preferably in the range of 1.5-2.0 inches high, and most preferably about 1⅞ inches high, from the bottom surface 22 to the shoulder 24.

Alternatively, the base 20 may be other than cylindrical, such as square, hexagonal, or octagonal, for example, but each base should have a shape and size that will fit inside the generally circular/cylindrical cup-holder CH systems of most vehicles. Alternatively, the base may be higher than the ranges listed above, but such a height might reduce the stability of the holder in the cup-holder and/or on another surface such as a table-top, and might cause the holder to be bumped by the driver or passenger during driving and/or shooting or tipped over in the hunter's home while the hunter is filling or working with the holder 10. With the preferred base 20 and receiving portion 30, the overall height of the invented holder 10 is in the range of 3.5-4 inches high, and most preferably about 3¾ inches high, resulting in a compact unit that conveniently holds about 13 pieces of ammunition.

The enlarged top portion or “receiver portion” 30 is sized to fit conveniently and in a stable manner in the space normally allotted for the top of a coffee or soda pop cup when it is held in the cup-holder. For use of one holder 10 according to the invention in a single cup-holder, the preferred receiving portion 30 is a cylindrical body about 4 inches in outer diameter. While various shapes and contours of receiver portion are envisioned by the inventors, the most efficient use of space is to have the receiving portion being of a generally uniform diameter all along its height, which maximizes the number of shell or cartridges it can hold per surface area of the top surface of the holder.

In the top surface 32 of the holder are bores 40 that extend into the receiving portion vertically, that is, parallel to the axis of the generally cylindrical holder. The bores are sized in diameter and depth, and arranged on the top surface, to hold a plurality of shells 12 and/or cartridges 14 preferably perpendicular to the top surface 32 of the holder 10 and perpendicular to the bottom wall 38 of the well 39 of the cup-holder.

A preferred version of the invented holder 10 has an outer ring 50 of eight shot-gun-shell-sized bores around the outer portion of the top surface 32. This outer ring 50 of bores may be described as a 3 inch “bolt circle” wherein the bores 40′ for 12 gauge shells are spaced 1.148 inches part in the circle. Bores for 12 gauge shotgun shells will leave about 0.10 inches between the outermost wall portion 41 of the outer bores and the outer wall 31 of the receiving portion. An inner ring 60 of rifle-cartridge-sized bores 40″ is placed concentrically inside the outer ring 50 of bores, with another rifle-cartridge bore 40″ being positioned in the center, preferably at the center axis of the holder. This inner ring 60 of cartridge-sized bores 40″ may be described as a 1⅝ inch “bolt circle” with the bores 40″ being 1.149 inches apart in the ring.

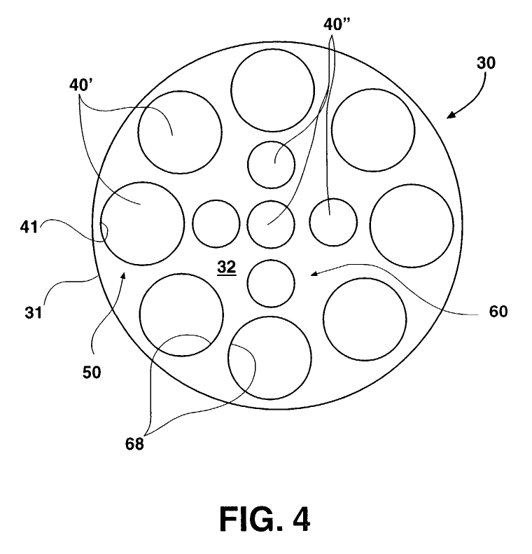

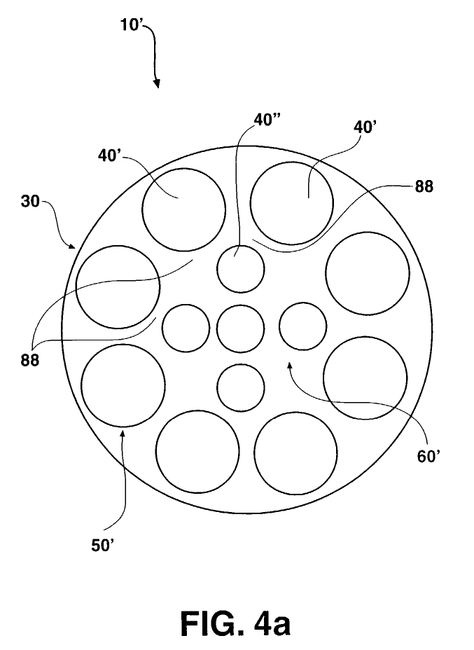

As shown in FIGS. 1-4, the outer ring 50 may be positioned relative to the inner ring 60 so that four of the cartridge bores 40″ are aligned with and near four shell bores. In an especially-preferred arrangement for alternative holder 10′, shown in FIG. 4a, the outer ring 50′ is, in effect, rotated relative to the inner ring 60′, so that the cartridge bores 40″ are positioned between shell bores 40″. For this alternative receiving portion 30″ having the same outer diameter as the receiving portion 30 in FIGS. 1-4, this alternative arrangement of bores provides for thicker walls 88 between the bores and, hence also provides more space between portions of the shells and cartridges for accurate grasping of the ammunition.

The above arrangement fits well inside the 4 inch diameter receiving portion 30, and can be adapted, for example, for 20 gauge shells rather than 12 gauge shells. A ring of bores for 20 gauge shotgun shells will leave about 0.167 inches between the outermost wall portion of the outer bores and the outer wall of the receiving portion. Preferably, in this preferred arrangement, all bores are at least 1⅛ inches apart at center. Alternatively, other arrangements of shells and cartridges may be used, for example, bores sized for shells may be near the center axis and bores sized for cartridges may be near the outer perimeter of the holder.

The preferred receiving portion is radiused as its top outer corner 35 with a 1/16 inch radius. All the other corners, for example, shoulder corner 37, are preferably radiused at ⅛ inch.

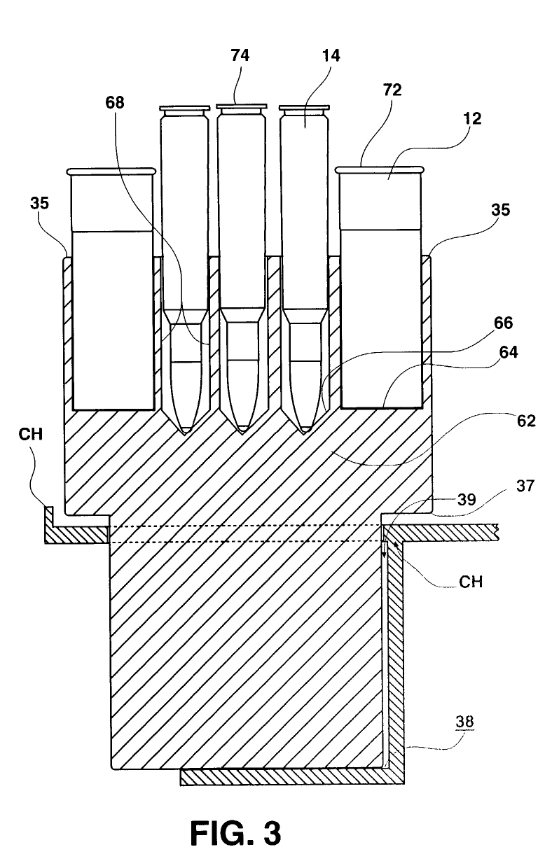

The preferred bores 40 are parallel to each other and extend through the top surface 32 and into the center area 62 of the holder. Each bore 40 has a closed bottom, creating a floor 64 upon which the shell or cartridge rests. The bore floor may be flat and perpendicular to the axis of the holder, for example, as in the floor 64 shown for the shot-gun shells in FIG. 3. Or, tapered, or curved floors may be used, for example, as in the floor 66 shown for the rifle cartridges in FIG. 3. Alternatively, other shaped floors may be used, as convenient during manufacturer and as are judged to be non-damaging for the ammunition cartridges.

Preferably, the shells 12 and cartridges 14 do not hang on the top surface 32 of the holder, do not hang through or extend all the way through the holder 10, but, instead, stand generally vertically in their respective bores 40 supported by the floor 64, 66 of each bore and leaning against the side wall(s) 68 of the bore. Preferably, no attachment is formed between the shells or cartridges and the holder, and preferably no lock or latch is used to hold the shells or cartridges in the holder. One of the main features of the invented holder that makes it so effective and safe to use is that the shells 12 and cartridges 14 are not trapped or hung in the holder, but, instead, are easily lifted by their top ends from the holder with the user's one hand.

While the invented holder 10 may be made so that the ammunition cartridges fit in the bores with either end of the cartridges upwards, the preferred positioning is for the shells and cartridges to have their “rear ends” 72, 74 (that which is impacted by the firing mechanism) upwards in the holder. This will be comfortable for most hunters who will prefer grasping shells by their rims 82, and the cartridges by their non-conical ends 84.

The shell and cartridge bores are sized in length, from the top surface 32 to their respective floors 64, 66, to properly hold the ammunition cartridges with their upper ends protruding up from the top surface. This protruding positioning, and the space between the bores, gives the user room to grasp the upper ends of the individual shells and cartridges, without any question of which one is being grasped and without a significant chance of fumbling or dropping the shell or cartridge.

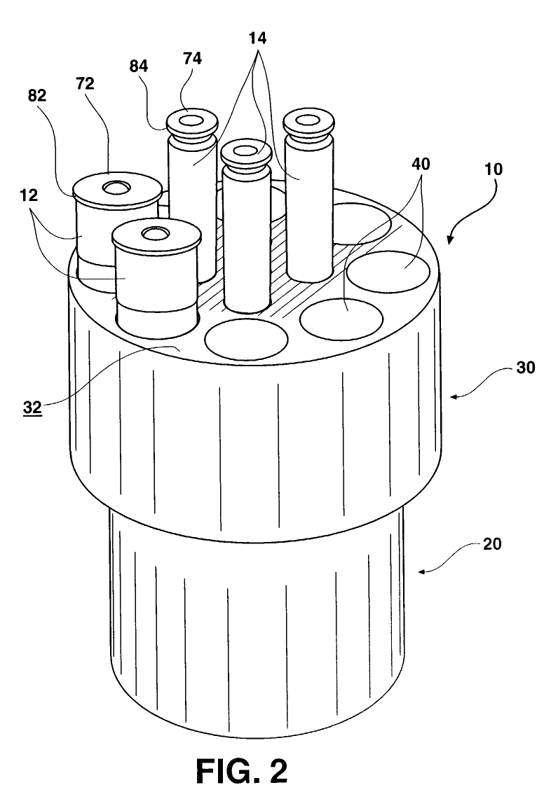

For example, the preferred depth of bore is designed so that the top surface of the shells and cartridges will protrude from ¼ to 2 inches above the top surface of the holder, and most preferably from about ½-1½ inch above the top surface of the holder. Further, it is especially preferred that the bores are designed so that the rifle cartridges protrude ⅜-½ inches higher up from the receiving portion top surface than the shot gun shells protrude. See, for example, FIGS. 2 and 3. This will result in the rifle bores (preferred inner ring bores and axis bore) hold the rifle cartridges higher up than the shells, mainly for the purpose of differentiating the rifle cartridges from the shot-gun shells, and also for a pleasing aesthetic appearance.

The differences in the heights of protrusion of various shells and/or cartridges above the uppermost surface of the invented holder creates a type of three dimensional pattern of ammunition cartridges. In other words, the three dimensional pattern of having shells in different rings or rows on the holder than the cartridges, and of having shells at different heights than the cartridges, provides easier and more sure identification and selection of the desired ammunition cartridges. In addition to the shells being distinguished from the cartridges by these patterns and heights, other features may be used for differentiation, for example, 12 gauge shells being positioned lower and in an outer ring, while 20 gauge shells are positioned in an inner ring and at a higher level.

As shown in the preferred embodiment, a single holder may have bores for both shells and cartridges. Or, a single holder may have bores for only shells or only cartridges. A holder according to the invention may be designed for only one gauge and one caliper, for example, or only for 12 gauge shotgun shells and only for 30-06 rifle cartridges. Or, bores for various gauges of shotgun shells may be included in the same holder, for example, both 12 gauge and 20 gauge bores may be in a single holder. Also, bores for various calipers of cartridges, for example, 30-06 cartridges or 30-30 cartridges, may be included in a single holder. Individual hunters may have different habits and preferred ammunition, and the holder may be designed accordingly. A ammunition manufacturer may want to produce holders according to the invention featuring particular ammunition cartridges or combinations of ammunition cartridges, depending on their marketing campaigns and newly-introduced guns, for example.

A smaller diameter receiving portion may be made to accommodate hunters and vehicles wherein two of the invented holders are to be placed side-by-side in two cup-holders available in the vehicle. For example, a Ford Explorer or pickup has two recess-style cup-holders close together between the two front seats. While two bases described above will fit side-by-side in these cup recesses, the receiving portions of the two holders should be made with smaller diameter receiving portion so that two holders will properly fit in the side-by-side cup-holders. This way, both the driver and the passenger may carry, install, and use their preferred selection of ammunition, without using or interfering with the other person's selection.

This smaller diameter holder may have about a 3.5 inch outer diameter receiving portion, with an outer ring of bores that may be described as a “3 inch bolt circle” with bores 0.956 inch apart on the ring. The inner ring of bores may be described as a 1¼ inch bolt circle with bores 0.883 inch apart on the ring. This arrangement may also accommodate 8 shells in the outer ring and four cartridges in the inner ring plus one cartridge at the center axis, for a total of 13 ammunition cartridges.

Based on the description above and the list below of dimensions of commonly-used cartridges and shells, one may arrive at bore diameters and bore depths that will work well in the invented holder. For example, one may see that bores for popular cartridges may be in the range of about 0.37 to about 0.47 inches, and bores for popular shells may be in the range of about 0.68 to about 0.8 inches. Preferably, the bores are not so small in diameter that the ammunition cartridges become wedged or stuck in the bores, and not so large that the ammunition cartridges lean over significantly in the bores. Preferably, the bores for the shotgun shells are about 0.010 inches (10/1000 inch)greater in diameter than the widest part of the shell that will be used in that bore. Preferably, the bores for the rifle cartridges are about 0.005 inches (5/1000 inch) greater in diameter than the widest part of the rifle cartridge that will be used in that bore.

Rifle Cartridges:

| | Diameter | Length |
|---|---|---|
| Caliper | (Inches) | (Inches) |
| 30—30 | 0.400 | 2½ |
| 32 | 0.400 | 2½ |
| 308 | 0.455 | 2¾ |
| 30-06 | 0.450 | 3⅛ |
| 270 | 0.450 | 3 5/16 |
| 303 sav. | 0.420 | 2½ |
| 444 sav. | 0.455 | 2½ |
| 35 | 0.430 | 2⅜ |
| 6 mm | 0.435 | 2¾ |
| 222 | 0.355 | 2⅛ |
| 223 | 0.355 | 2⅛ |

Shot gun Shells

| | Diameter | Length |
|---|---|---|
| | (Inch) | (Inch) |
| 12 gauge - 2¾ inch | 0.788 | 2 5/16 |
| 12 gause - 3 inch | 0.788 | 2 11/16 |
| 16 gauge | 0.715 | 2¾ |
| 20 gauge - 2¾ inch | 0.670 | 2¼ |
| 20 gauge - 3 inch | 0.670 | 2¾ |

In the preferred embodiments, the bores for the cartridges are drilled or cut or otherwise formed to have depths less than the length of the cartridge, thus, translating to the cartridge protruding out from the holder a distance equal to the difference in said lengths. For cartridges that are 2½ inches long, the bore may be, for example, in the range of 1-1.5 inches deep. For a one inch deep bore, the 2½ inch cartridge would protrude 1.5 inches, and for a 1½ inch deep bore, the 2½ inch cartridge would protrude one inch. Alternatively, other depths may be used, as desired by particular manufacturers or users. In general, the deeper the bore, the more stable the cartridge is in the bore, but it is slightly harder to grasp the cartridge, for removal.

Likewise, the bores for the shells are drilled or cut or otherwise formed to have depths less than the length of the shell, thus, translating to the shell protruding out from the holder a distance equal to the difference in said lengths. For shells that are 2¼ inches long, the bore may be, for example, in the range of 1¼ to 1¾ inches deep. For a 1¼ inch deep bore, the 2¼ inch long shell would protrude 1 inch above the receiving portion top surface, and for a 1¾ inch deep bore, the 2¼ inch long shell would protrude ½ inch above the top surface. Alternatively, other depths may be used, as desired by particular manufacturers or users. In general, the deeper the bore, the more stable the shell is in the bore, but it is slightly harder to grasp the shell for removal.

Preferably, as described earlier in this Description, the bores for the cartridges and the bores for the shells are sized in length relative to each other so that the cartridges protrude a different amount than the shells. Preferably, this difference is about ¼-¾ inch, and more preferably ⅜-½ inch, more protrusion for the cartridges, which are preferably generally at or near the center axis of the holder. While these are some guidelines, the bore depths may vary, depending on the manufacturer or user's tastes and how much more the cartridges are desired to protrude compared to the shells. In FIG. 3, accomplishing the desired difference in protrusion of the cartridges compared to the shells is accomplished by providing cartridge bores that are deeper than the shell bores. The extent to which the cartridge bores are deeper is determined by the relative length of the shells and cartridges. Further, for alternative shells and cartridges of different relative lengths, the cartridge bores may be less deep than the shell bores in order to obtain the desired difference in protrusion.

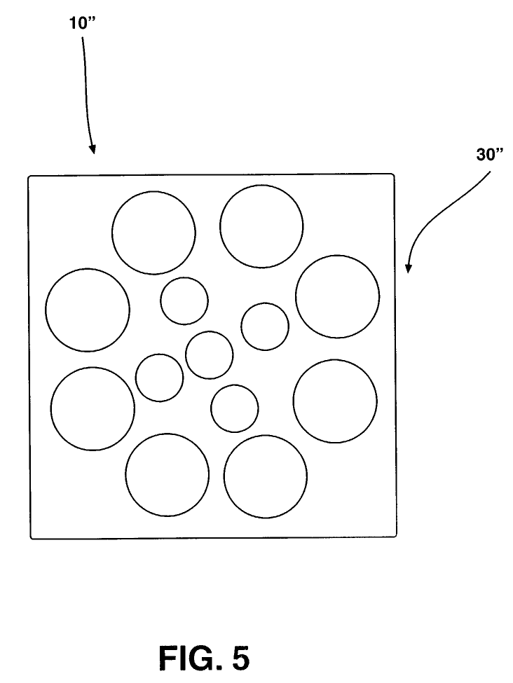

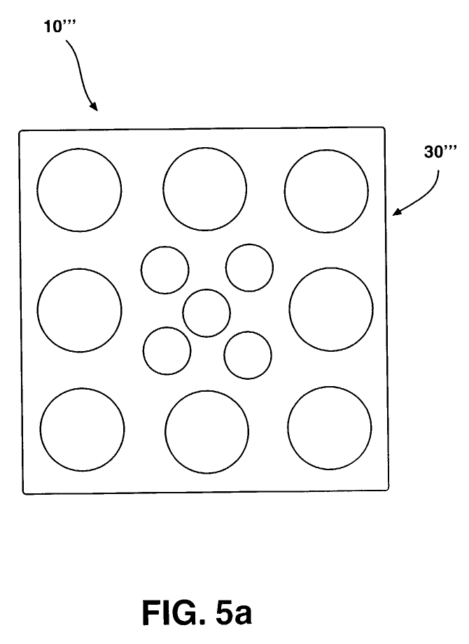

The preferred invented holders may be made economical out of round stock, such as wood, metal, plastic, or other materials. Various colors may be used, with patterns, logos, advertising, and other indicia. As alternatives to round stock and a resulting round holder, other shapes may be used, for example, the square-topped holders 10″, 10′″ shown in FIGS. 5 and 5a. The bores of the FIG. 5 receiving portion 30″ are arranged in a pattern similar to that in FIGS. 1-4, and the bores in FIG. 5a are arranged in a pattern that may be called rows and columns. Various geometric arrangements may be designed for special effects or to please individual users.

The preferred holder is a single piece, without moving parts and without removable parts except that the cartridges and shells are easily insertable and removable. Optionally, the two portions of the holder, the base and the shell- and cartridge-receiving section, may be two separate pieces that are connected together by conventional wood-, plastic-, or metal-working methods. Preferably, the invented holder is a solid piece of material, except for the bores, and the holder is heavy enough to remain in the vehicle cup-holder even when loaded with few or no shells or cartridges. The holder may optionally have a rubber or other gripping surface or liner for interacting with the cup-holder to prevent the holder from spinning in the cup-holder. Optionally, the holder may have some adhesive or double-sided tape on the bottom surface of the holder, for those hunters that are not expecting to remove the holder from the vehicle.

Although this invention has been described above with reference to particular means, materials and embodiments, it is to be understood that the invention is not limited to these disclosed particulars, but extends instead to all equivalents within the scope of the following claims.

I claim:

1. An ammunition holder for hunters having an upper portion and a lower portion and an axis;
the lower portion being adapted to fit into a vehicle cup-holder and having an outer diameter;
an enlarged upper portion generally coaxial with the lower portion and having an outer diameter larger than the outer diameter of the lower portion, said upper portion having a top surface with a plurality of bores generally parallel to said axis, each bore having a bottom floor wall;
a plurality of ammunition cartridges slidably received in said bores so that a bottom end of each of said ammunition cartridges rests in its bore against the bottom floor and a top end of each of said ammunition cartridges extends up past said top surface for being accessed by a user and for being pulled upwards out of the bores for use.

2. The holder of claim 1, wherein the lower portion is cylindrical.

3. The holder of claim 1, wherein the upper portion is cylindrical.

4. The holder of claim 1, wherein said ammunition cartridges comprise shot-gun shells and said bores comprise a plurality of bores with diameters in the range of 0.68 to about 0.8 inches for receiving said shot-gun shells.

5. The holder of claim 1, wherein said ammunition cartridges comprise rifle cartridges and said bores comprise a plurality of bores with diameters in the range of 0.37 to 0.47 inches for receiving said rifle cartridges.

6. The holder of claim 4, wherein said ammunition cartridges further comprise rifle cartridges and said bores further comprise a plurality of bores with diameters in the range of 0.37 to 0.47 inches for receiving said rifle cartridges.

7. The holder of claim 1, wherein some of said ammunition cartridges are gun-shot shells and some of said ammunition cartridges are rifle cartridges, and wherein some of said bores receive said gun-shot shells and have a first bore length, and some of said bores receive said rifle cartridges and have a second bore length, wherein said first bore length is shorter than said second bore length and the gun-shot shells protrude up above the top surface less than the rifle cartridges protrude up above the top surface.

8. The holder of claim 1, wherein the holder is generally cylindrical, and said plurality of bores are arranged in concentric circles in said top surface.

9. The holder of claim 8, wherein said plurality of bores further comprise a bore in said top surface at the axis of the holder.

10. The holder of claim 1 that is cylindrical with an upper portion having an outer diameter and a lower portion having an outer diameter that is smaller than the upper portion outer diameter, wherein said plurality of bores extend into the upper portion and not into the lower portion.

11. An ammunition holding system for a vehicle, the system comprising:
a cup-holder in a vehicle having an inner diameter
an ammunition holder having a lower portion with a diameter smaller than said inner diameter, said ammunition holder lower portion being slidably received in said cup-holder;
the ammunition holder further having an upper portion extending upwards from the lower portion and having an uppermost surface, the upper portion having a plurality of elongated bores in the uppermost surface and extending into the upper portion;
a plurality of ammunition cartridges, each of said ammunition cartridges being slidably received in a different one of said bores so that a top end of each of said ammunition cartridges extends up above said uppermost surface to be grasped by a user;
wherein said ammunition holder is removable from said cup-holder by lifting said holder up from the cup-holder and said ammunition cartridges are removable from the ammunition holder by lifting said ammunition cartridges up from said holder.

12. The ammunition holding system as in claim 11, wherein the ammunition holder is cylindrical, and said upper portion is coaxial with said lower portion, and said upper portion has an outer diameter that is larger than said diameter of the lower portion.

13. The ammunition holding system as in claim 11, wherein said ammunition cartridges comprise shot-gun shells and said bores comprise a plurality of bores with diameters in the range of 0.68 to about 0.8 inches for receiving said shot-gun shells.

14. The ammunition holding system as in claim 11, wherein said ammunition cartridges comprise rifle cartridges and said bores comprise a plurality of bores with diameters in the range of 0.37 to 0.47 inches for receiving said rifle cartridges.

15. The holder of claim 13, wherein said ammunition cartridges further comprise rifle cartridges and said bores further comprise a plurality of bores with diameters in the range of 0.37 to 0.47 inches for receiving said rifle cartridges.

16. The holder of claim 11, wherein the holder is generally cylindrical, and said plurality of bores are arranged in concentric circles in said uppermost surface.

17. The holder of claim 16, wherein said plurality of bores further comprise a bore in said uppermost surface at the axis of the holder.

18. The holder of claim 11, wherein said plurality of bores extend from the uppermost surface into the upper portion and not into the lower portion.

19. An ammunition holder for insertion into a cup-holder in a vehicle, wherein said holder comprises a cylindrical upper portion with a plurality of elongated bores for slidably receiving individual ammunition cartridges, and a cylindrical lower portion adapted to be slidably inserted into a cup-holder of a vehicle, wherein said bores are parallel to each other and each of said bores is sized to receive only one ammunition cartridge so that ammunition cartridges do not touch each other when in the holder.

20. A holder as in claim 19, wherein the bores are arranged in an outer ring of eight bores, an inner ring of four bores, and a central bore at a central axis of the holder.

21. A holder as in claim 19, wherein the eight bores in the outer ring each have a diameter in the range of 0.68 to about 0.8 inches for receiving said shot-gun shells, and the four bores in the inner ring and the central bore each have a diameter in the range of 0.37 to 0.47 inches for receiving said rifle cartridges.
